(19) United States
(12) Patent Application Publication
(10) Pub. No.: US 2004/0133635 A1
(43) Pub. Date: Jul. 8, 2004

(54) Transformation of web description documents

(76) Inventors: Axel Spriestersbach, Karlsruhe (DE); Thomas Ziegert, Bad Homburg (DE); Thomas Springer, Dresden (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/673,561

(22) Filed: Sep. 30, 2003

Related U.S. Application Data
(60) Provisional application No. 60/428,901, filed on Nov. 26, 2002.

(51) Int. Cl. G06F 15/16

(52) U.S. Cl. 709/203; 709/246; 709/217

(57) ABSTRACT

A source document including at least one event is generated, meta information is associated with one or more of the events, and the events are transformed into one or more markup language specific representations of the events. The transformation of the event is controlled at least in part by the associated meta-information. Then, at least one markup language specific representation of the events are sent to a browser running on a client device. One or more markup language specific events are coded as HTTP-request parameters are received from the client device.

### CROSS-REFERENCE TO RELATED APPLICATION

This application claims priority to U.S. Provisional Application No. 60/428,901, filed Nov. 26, 2002, and titled TRANSFORMATION OF WEB DESCRIPTION DOCUMENTS.

### TECHNICAL FIELD

This disclosure relates to transforming single source documents to generate representations of the documents for multiple types of browser enabled devices.

### BACKGROUND

Web pages are commonly constructed using HTML (hypertext markup language), which has been developed for desktop computers and fast and stable wired networks. Browsers on desktop computers typically support extended features of HTML, such as frames, cascading style sheets (CSS), and active content such as, for example, JavaScript® or Java®, as well as proprietary extensions. However, most of the browsers on mobile devices available today, such as, for example, cellular telephones and personal digital assistants (PDAs), only support a subset of the current HTML standard, are limited to older versions of HTML, or use a device specific markup language (e.g., WML (wireless markup language) or cHTML (compact html)). Frequently, documents depending on browser-specific or device-specific features cannot be presented correctly, or may not be displayable at all if the devices do not support these features.

Mobile technology is an integral part of current and evolving computing environments. Because it provides access to enterprise data and applications anytime and in any place, mobile technology has a potential for the extension and enhancement of business applications. However, widespread use of mobile technology is currently hindered by, among other things, the ergonomics and usability of mobile devices and applications running on mobile devices. One cause of difficulty is the heterogeneity of device features (e.g., input and output capabilities, memory and processing power, operating system, supported multimedia formats and browser), connectivity and mark-up languages for mobile devices.

Two general techniques are used to handle this heterogeneity in web-based applications: manual adaptation and automated adaptation. The manual approach leads to multiple dedicated versions of web documents that provide good results in usability and design. Often, however, a great amount of effort is needed to create and maintain the consistency of web content for all versions of the document. The automated approach, by contrast, requires less effort to create and maintain web content because only one source document is used to generate the various versions of the target documents. However, because the automatic adaptation is usually based on heuristics and generic rules, the resulting documents are often aesthetically unpleasant to view, or even unusable.

One technique for the processing of user interactions with graphical user interfaces is eventing, which associates events with interaction elements that can be bound to actions for processing so as to decouple the interaction elements from a static document structure. Eventing is supported by existing mark-up languages, but the event mechanisms of different mark-up languages provide for different sets of events. For instance, while the current HTML standard offers a rich set of events, event support in WML is more restricted. Furthermore, the event processing is mostly based on local scripts. Specifically, events are not propagated to the server which hinders a remote processing of the events.

### SUMMARY

Implementations described below provide techniques for transforming and optionally splitting a single source document to generate appropriate representations for a wide spectrum of devices. A mechanism is provided to handle the interactions and data flow between the browser and the server independently from the structure and order of input elements and dialogs due to the changes in the structure of the source document, and independently from the corresponding changes in the structure of the GUI (graphical user interface) elements.

In particular, web documents may be described in a generic, device-independent document description language (DDL) based on, for example, XML (extensible markup language) or other suitable language. Similar to the automated approach, a single source document is generated. But in DDL the content is described independently from a certain mark-up language. In particular, DDL enables the manual addition of meta information at design time. For example, meta information may indicate alternative representations of semantically one element. Furthermore, through the manually entered meta information, elements can be declared to be optional, and may be omitted on devices with insufficient resources. The manually entered meta information is used to control the automated translation and adaptation process at runtime. Within this process, appropriate representations of GUI elements are selected and the document is optionally fragmented into subdocuments and transcoded into a certain mark-up language appropriate to the resources of the target device and execution environment.

According to one general aspect, a source document including at least one event is generated, meta information is associated with one or more of the events, and the events are transformed into one or more markup language specific representations of the events. The transformation of the event is controlled at least in part by the associated meta-information. Then, at least one markup language specific representation of the events are sent to a browser running on a client device. One or more markup language specific events coded as HTTP-request parameters are received from the client device.

Implementations may include one or more of the following features. For example, the source document may be generated to include at least one generic, markup language independent, event. The source document may be a web document, and the generic, markup language independent, events may be described in a generic, device-independent document description language based on XML or other suitable language.

The meta information may be manually associated with one or more of the events. In one implementation, the meta information includes alternative representations of semantically one element. In another implementation, the meta information enables elements to be declared to be optional and to be omitted on client devices with insufficient resources.

The events may be automatically transformed. Also, the source document may be fragmented into two or more subdocuments, and the fragments may be transformed into one or more markup language specific representations appropriate to the available resources of a client device and the execution environment of the client device. The markup language specific representations may include an HTML representation, a WML representation, and a cHTML representation. The generic events may include one or more of a navigation event, an input event, a relation event, and a submission event.

In a second general aspect, an apparatus may include an adaptation framework. The adaptation framework may include an event dispatcher configured to process an incoming event and control the invocation of one or more processes based upon the event. The adaptation framework also may include a fragment getter invoked by the event dispatcher and configured to retrieve a portion of a document from a local data store, a processor invoked by the event dispatcher and configured to communicate with the fragment getter and configured to transform the document into a device specific format, and a fragmentation filter invoked by the event dispatcher configured to fragment the document into one or more parts for display by a client device based upon an availability of one or more resources at the client device.

Implementations may include one or more of the following features. For example, the adaptation framework may includes a client recognizer configured to receive information from a client device and to receive device profile information. The fragment getter may generate the document from a local data store based upon user profile data stored in a user profile. Also, the adaptation framework may include an image filter configured to adapt an image according to device profile information and user profile information.

The fragmentation filter may include a first fragmentation filter configured to manage caching of one or more fragments of the document, and configured to perform a fragmentation of the document. A fragmentation validation filter may communicate with the first fragmentation filter and may be configured to determine whether the fragments may be rendered on the client device without exceeding the resources of the client device. If not, the fragmentation validation filter may enable further fragmentation by the first fragmentation filter.

The one or more filters may be executed based upon filter configuration data stored in a filter configuration file, and the next filter to be executed may be determined by the current filter being executed.

The details of one or more implementations are set forth in the accompanying drawings and the description below. Other features will be apparent from the description and drawings, and from the claims.

### DESCRIPTION OF DRAWINGS

FIG. 1 is a flow diagram of a two-step event transformation.

FIG. 2 is an exemplary user interface illustrating aspects of an implementation of the two-step event transformation of FIG. 1.

FIG. 3 is an illustration of an exemplary DDL document structure.

FIG. 4 is an exemplary system diagram of a system to perform the two-step event transformation of FIG. 1.

FIGS. 5, 6, 7, and 8 are exemplary user interfaces illustrating aspects of implementations of the two-step event transformation of FIG. 1.

### DETAILED DESCRIPTION

The approach described herein is a combined approach. Web documents are described in a generic, device-independent document description language (DDL) based on XML. Similar to the automated approach only one source document is generated, but the content is described independently from any particular markup language. In particular, DDL enables the manual addition of meta information at design time. For example, meta information may indicate alternative representations of semantically one element. Furthermore, using the manually entered data, elements can be declared to be optional and may be omitted on devices with insufficient resources (e.g., display area, memory, color). The manually entered meta information is used to control the automated translation and adaptation process at runtime. The adaptation process may include device identification and classification, session management, data input validation, dialog fragmentation, transcoding, and mechanisms to adapt the content to the capabilities of the user device and connectivity. Therefore, a proxy-based framework is provided that enables the addition, removal, and substitution of modular designed adaptation mechanisms according to information about the execution environment. Using this process, appropriate representations of GUI elements are selected and the document is optionally fragmented into subdocuments and transcoded into a particular markup language that is appropriate to the resources of the target device and execution environment.

The term adaptation generally describes the ability of a system to react to changes within its execution environment. In the context of web-based services, the structure, content data, and the transmission of the data are exemplary subjects for adaptation.

The approach described herein uses a single source document that is transformed and optionally split to generate appropriate representations for a wide spectrum of devices. These changes in the structure of the source document, and therefore the change in the structure of the graphical user interface (GUI) elements, require a mechanism to handle the interactions and data flow between the browser and the server independently from the structure and order of input elements and dialogs. The implementation described herein supports events which do not depend on a particular mark-up language, and which can be processed on the client and/or on the server.

The two step transformation supports a transcoding approach into arbitrary target markup languages. The transformation supports client-side and server-side event processing (e.g., script generation for the client side, and event propagation for server side). The designer defines his/her own application independent events, and the adaptation framework performs syntactic transformations, where the events are independent from adaptation framework. Fine grained events for the client and server side (e.g., text input or button pressed) may be supported. Generic events are transcoded into markup language specific event, which enables event support for various markup languages with different event sets. No information about events needs to be stored in the adaptation framework because all information about an event is transmitted within the two step transformation.

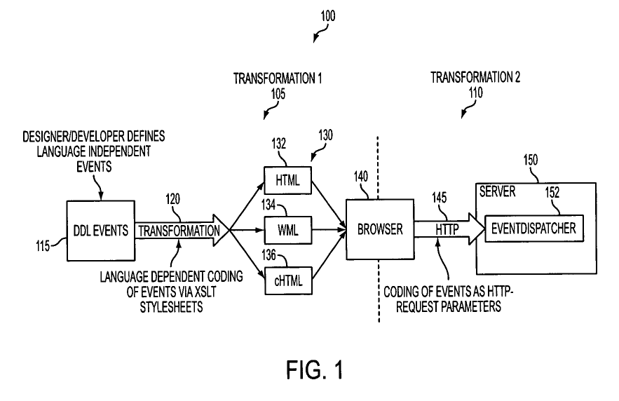

Referring to FIG. 1, an exemplary process 100 for a two step transformation of the events is shown. A first transformation process 105 transforms the generically described events into a mark-up language specific representation which is sent to the browser. In particular, a designer/developer defines language independent DDL events 115. Next, at 120, the language independent DDL events 115 are transformed into one or more language dependent codings 130 of the DDL events 115. For example, the language independent DDL events 115 may be transformed into language dependent codings for HTML 132, WML 134 and other language dependent codings 136 such as, for example, cHTML. The transformation 120 may be done, for example, using XSLT Stylesheets. The appropriate language dependent coding 130 may be executed on the browser 140. For example, the HTML coded transformation 132 may be executed on a browser running on a desktop computer and the WML coded transformation 134 may be executed on a browser running on a mobile device.

In a second transformation process 110, the events 115 are coded as HTTP-Request parameters and are propagated back to the server. In particular, events are coded as HTTP request parameters 145 and propagated from the browser 140 to the server 150. For example, the events 115 may be propagated to an EventDispatcher 152 running on the server 150.

A generic event description is provided and, as part of this implementation, the user input and data flow between browser 140 and server 150 is described via a set of independent events. In process 100 of FIG. 1, the generic event description in DDL of events 115 may be based on XML Events. Generally, there are four classes of events which may occur during the use of a web document: 1) navigation events; 2) input events; 3), relation events, and; 4) submission events. A navigation event occurs if, for example, a user follows a link. More generally, a navigation event occurs if a new document is requested as a result from an interaction. An input event occurs if, for example, a single input element is filled out or changed by the user. A relation event occurs if, for example, relations between input data exist which have to be processed additionally to the single input events (e.g., the relation between the payment type and the detailed payment information). A submission event occurs if, for example, a form is completed and the form data is submitted to the server (e.g., via the submit button of the form). More generally, a submission event may indicate the completion of a logical process within an application which requires processing in the backend (e.g., necessary payment information is collected, now the information has to be validated and the transaction has to be performed).

As discussed above, the DDL syntax of the event description may be based on XML Events, an example of which is shown in Table 1.

TABLE 1

| Element | Attributes | Description |
|---|---|---|
| Listener | Event (NMTOKEN), | defines the type of the event |
| | observer (IDREF), | id of the element with |
| | | which the listener is |
| | | to be registered |
| | handler (URI), | URI of the action to be performed |
| | priority (NMTOKEN) | an integer which defines |
| | | the position of that event |
| | | in a sequence of events |

Referring again to the first transformation process 105 of FIG. 1, DDL events 115 are transformed into a markup language specific representation (120) because the generically described events typically need to be transformed into a markup language specific representation to be interpretable by the client device. The transformation can result in a representation which enables client-side or server-side event handling. To enable client-side event processing, the events are transformed into a language specific event with the same semantic. Furthermore, each event handler should be invokable and executable by the client browser (e.g., the handler is coded in java script and included in the document during the transformation). To enable server-side event processing, the events are transformed into language specific elements in which data is sent to the server via form submission. In HTML, hidden input elements within a form can be used. The event information is set as the value of the input element. In WML, a similar transformation into postfield elements may be used.

As discussed with respect to the second transformation process 110 of FIG. 1, to propagate the events back to the server 150, the events may be encoded as HTTP-Request parameters. This process is based on the submission of form data by the user agent.

For client-side event processing, the handler ensures that results of the event processing are encoded correctly and set as the value of an input element. For server-side event processing, the encoding for the second process 110 done together with the first process 105.

In one implementation, the following rule may be used to encode an event (each HTTP-Request parameter includes a name-value pair):

name=“event.”+event+“.”+observer

value=handler+“;”+priority

The above variables correspond to the attributes of a listener element, such as, for example, those listed in Table 1.

An example of the process 100 will now be described. The below listed variables correspond to the attributes of a listener element, such as, for example, those listed in Table 1.

Referring to the first transformation process 105, a generic DDL event description 115 may be defined by a designer/developer as follows:

```
...
<part name=“bankid”>
  <property name=“type”>textinput</property>
  <property name=“hsize”>14</property>
  <property name=“vsize”>1</property>
  <property name=“description”>Bank ID</property>
  <listener event=“validation” observer=“bankid” handler=“EventHandler.
validateBankId” priority=“10”/>
</part>
...
```

The generic event description may be transformed (120) to one or more device-dependent markup codings 130 as follows:

```
HTML 132:
<input type=“text” name=“bankid” size=“20”/>
<input type=“hidden” name=“event.validation.bankid” value=
“.EventHandler.validateBankId;10” />
WML 134:
<do type=“accept” label=“Submit”>
  <go href=“http://submit_bank”>
    <postfield name=“bankid” value=“$bankid”/>
    <postfield name=“event.validation.bankid”
        value=“EventHandler.validateBankId;10”
```

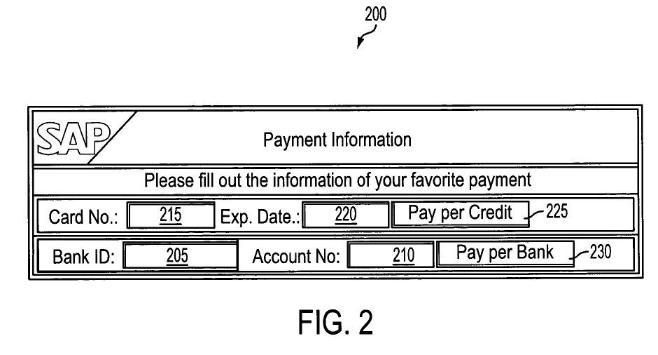

FIG. 2 shows an example of a payment information user interface (UI) 200. The UI may include several fields, such as a BankID 205, in which the user may enter data. Other fields may include an Account Number field 210, a Card Number field 215, and an Expiration Date field 220. The UI 200 may also include actionable items such as a Pay per credit card button 225 and a Pay per Bank button 230.

As discussed with respect to process 110 of FIG. 1, an event 115 may be coded as an HTTP request parameter 145. In the example shown below, the event 115 is coded as an HTTP request parameter for both HTML and WML using a universal resource locater (URL) back to the web-server:

http://localhost:8080/PizzaService/payment.ddl?

bankid=1023299234&accountno=12/04&

event.submission.bank=EventHandler.checkBalance&

event.validation.bankid=EventHandler.validateBankId&

event.validation.accountno=EventHandler.validateAccountNo

Adaptation of web documents will now be discussed in more detail. Web documents typically consist of internal elements (e.g., text and GUI elements) and external elements which are linked to the document (e.g., images, audio, and other media objects). If the links do not contain any information about the referenced elements as it is the case for HTML, these elements can be only be involved in the structure adaptation by using heuristics. However, if information about linked elements is available, a finer granularity of adaptation is possible. For instance, in one implementation, lossy operations could be performed according to a priority value describing the importance of the elements for the “look and feel” or the semantic within the document. For instance, in a document adapted to a small display size, elements with a low priority should be omitted while elements with a high priority are kept unchanged, rather than reducing the size of all images equally.

In another implementation, techniques such as fragmentation may be used for a loss-less approach for structure adaptation. In particular, fragmentation prevents the omission of elements by distributing the elements among several pages which can be navigated via links. The relationship between elements (e.g., an image and its caption, or a text field and its description) may be expressed by defining atoms (which are indivisible) and groups of atoms (which are semantically related but can be divided if necessary). As an example of fragmentation, tables can be transformed into one sub-page per table cell, in a top-down, left-to-right order.

The single elements of web documents can be adapted by converting their properties (e.g., resolution and color depth of an image) and data representations (e.g., file format). Furthermore, the quality may be adjusted by applying lossy compression. The replacement of elements is a powerful mechanism to reduce the amount of data or to overcome incompatibilities. A wide range of mechanisms is available to change the type of the element (e.g., speech to text or video to image sequence) while keeping the semantics of the original element as much as possible. Decisions for the adaptation of the described mechanisms should take into account issues such as the properties of the element that are adaptable, the results of the adaptation, and any additional information needed for the adaptation process.

In a web document, text is normally structured into several parts (e.g., title, headings, sections, abstract and meta information such as author, creation date, or keywords) describing the semantics of the text within a document. To adapt text, only certain elements are used to create new views. For instance, a table of contents can be created out of the headings, the abstract could be extracted together with meta information about the author, or a certain part of the document could be selected according to given keywords. Furthermore, the first “x” words or the first sentence of a section may be presented to create an overview of the section. The goal of adapting structured text is to provide several views to enable the user to have a quick overview of the whole document, and to fragment large documents according to a given display size. The reduction of data volume is important for devices with restricted main memory, such as mobile phones. The fragmentation of large documents into pages, which fit to the display size, would provide for a sequential viewing of the pages of the document. This fragmentation mechanism reduces the amount of data transferred over the network if not all pages of the document are viewed (known as lazy evaluation). To adapt text documents, meta information about the structure is required. This information can be explicitly added manually or extracted from unstructured text by heuristics. Additional keywords given by the user can be used to search and extract interesting sections.

Images and text are the most frequently used elements in web documents, and the image size has an influence on the size of the rendered document. The adaptable properties of an image include the resolution, color depth, a quality factor expressing the information depth of the image (e.g., the compression factor for JPEG images), and the file format. A goal of image adaptation is to reduce the file size while keeping as much of the information as possible. According to the reduction of the amount of transferred data, thumbnails with a link to the original image may be created leaving the decision of the transfer to the user. Sections of an image may also be extracted to give the user a preview of an image. If the available bandwidth is too low or the display size is too small, images may be replaced by a textual description.

Typically, the last communications link to mobile devices is a low bandwidth, high latency, error-prone, and high cost network connection. A proxy approach enables the adaptation of documents before the transfer. Functions usually performed by the client device may be performed by the proxy. In the case of network errors, the proxy may receive and cache messages and data for the client to prevent data loss. The proxy also allows the installation of adaptation mechanisms as performed in the approach described above.

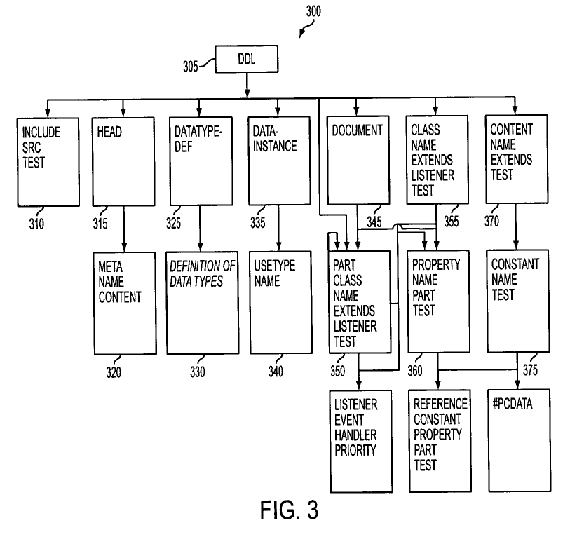

FIG. 3 illustrates an exemplary DDL document structure 300. The DDL should be simple and compact, but also functional, powerful, and extensible. The Document Description Language (DDL) follows the concept of decoupling of structure, representation and content, and the concept of inheritance. Furthermore, constraints on user input in forms can be specified which allow automated input validation by the adaptation software.

In one implementation, the DDL may be an XML-based meta language. The DDL describes a structure of abstract elements. Properties can be assigned to each element. Furthermore, a “test”-attribute can be defined for some of the elements which enables the specification of conditions for their inclusion. A condition is defined by an XPath-expression applied to the client profile.

In the example of FIG. 3, the root element is <ddl> 305. It may be followed by optional include statements 310, header information 315, and datatype definitions 325. The document section 345 describes the visible document itself. Parts 350, classes 355, and content 370 may be defined inside or outside the document section 345, but only the part elements 350 inside will form the web page. All other elements are library elements that can be used for inheritance.

With the <include> statement 310, external DDL files can be included to allow the creation and reuse of DDL libraries. Within the <head> section 315, meta information 320 of the document (e.g., author or creation date) can be described. There is typically at most one <head>-element 315 per DDL document. The data definition 325 section allows the definition of data types 330 and data instances 335, 340 which are used to validate input of web forms. From a set of basic data types, complex data types can be derived within <dataTypDef> elements 325. Several restrictions (e.g., min and max value for integer data) may be assigned to each built-in basic data type to allow precise specification of valid inputs. Type information can also be used to optimize the presentation of input elements. For instance, a calendar could be displayed to prompt for a date. Each data type is assigned a unique name which may be used to define the type of <datainstance> elements 335. Input elements of web forms can be bound to data instances via the unique names of data instances. Thus, the user interface and the data is separated to enable the adaptation of the representation of input elements.

Within the <document> 345 section, the structure of the document is described. There is typically at most one <document>-element 345 per DDL document. As mentioned, it includes the elements forming the actual web page, and is formed by parts 350, classes 355, and content elements 370.

The <part>-elements 350 are used to model the abstract structure of a document. They may be nested and may have properties assigned to them. The optional “extends”-attribute refers to another part by a unique logical name to inherit properties from. Through the optional “class”-attribute, a class can be assigned to a part. If a part belongs to a class and additionally inherits from another part, properties of the class have higher priority than those inherited from another part and therefore override them. The listener attribute property also may be included.

The <class> element 355 defines a class of parts. It includes a set of properties. The properties of a class are adopted by its instance parts. Similarly to the parts 350, the optional “extends”-attribute can be used to define class inheritance. The listener attribute property also may be included.

Through the <content> elements 370, DDL realizes the decoupling of structure and content. The <content>-element 370 includes a set of data items (e.g., a <constant>-element 375) that can be referenced by <property>-elements 360 or other <content>-elements 370.

The <property> elements 360 are used to assign properties (e.g., styles for the presentation or abstract properties) to parts 350 or classes 355. The semantics of the properties are defined separately, and future extensions may be developed without the need to change the syntax (DTD) of DDL. Only the DDL renderers (usually in the form of XSLT style sheets), for the adaptation to device specific languages, would need to be extended or adapted to be able to interpret new properties.

Parts are assigned semantic types specifying the interpretation of the particular <part>-element 350 by the renderer. In one implementation, a set of parts may be defined to create web documents. Within a container part, arbitrary parts can be grouped together to specify a certain layout or to define atoms for the fragmentation. Structured text can be described, for instance, by the paragraph and abstract part. Further parts may define attributes of text, images, and tables. To create forms, a form part may be defined, part elements for user input related to HTML forms (e.g., textinput, radiogroup or checkbox), and a submit part to finish a form.

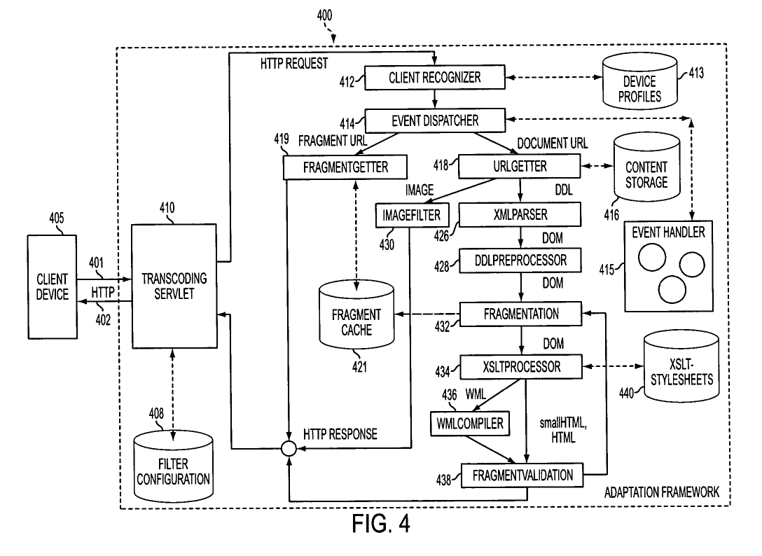

FIG. 4 illustrates an exemplary adaptation framework 400 for carrying out the process of FIG. 1. The adaptation framework 400 will typically be used to adapt web content, but other content may be adapted by the framework 400. In one implementation, the adaptation framework may use the Xalan-XSLT-processor as well as the Xerces-XML-parser by the Apache-Group. The adaptation may be performed via a chain of filters where a filter may be a Java class, and may implement one or more of the interfaces HTTP filter, request filter, and reply filter. Filter classes inherit some common functionality from the abstract superclass filter-support.

The sequence of filters in the request processing chain may be determined by a configuration file 408. A transcoding servlet 410 processes the configuration information and controls the successive execution of the filters. Each filter has a test method that determines by a boolean return value if this filter should be applied in the current adaptation process. For instance, requests from WML clients may require the invocation of the WMLCompiler 436. In the eventing architecture, the transcoding servlet 410 is used to receive client requests from the client device 404.

The process for adaptation of web content may use information about the client device 405, and may also include information about the network connection and user preferences. This information may be determined at the beginning of processing an HTTP request 401 in the ClientRecognizer 412. In one implementation, the client device and/or network profiles 413 are determined through a user-agent HTTP header field or a transmitted CC/PP profile. The latter approach typically provides more information, and more accurate information, about the client device and network connection. A CC/PP capable web browser may also be emulated by use of a client-side HTTP proxy inserting a CC/PP profile into the HTTP header.

The adaptation framework 400 may include iterations, i.e., a loop in the filter chain. To allow for loops, a filter may optionally determine its successor. An example of a loop is the iterative fragmentation of documents by Fragmentation process 432 and FragmentationValidation 438.

EventDispatcher 414 is responsible for the structural analysis of a document and the generation of a new presentation. The EventDispatcher 418 may include an EventHandler 415, a FragmentGetter 419 and URLGetter 418. The EventDispatcher 418 retrieves a requested paragraph generated by FragmentGetter 419 from the local cache 421. This happens, for example, when a user chooses a particular section from the table of content or a curtailed presentation of a paragraph. The EventDispatcher 414 and the FragmentGetter 419 may process a document according to the definitions in a user profile. This includes displaying or hiding of particular meta information or abstract of a document, creation of a table of contents from section captions with links to section text, or the reduction of sections to the first sentence. Removed data is stored in a local cache 421 or content storage 416 to enable later retrieval by future client requests in conjunction with URLGetter 418.

The ImageFilter 416 adapts images within a document according to user preferences and properties of the client device. First it checks if a particular image needs to be adapted or may be transmitted to the client unchanged. Then, the ImageFilter 416 replaces images within a document with a adapted image and a link to the original image. Additionally, it converts images, e.g., BMP into JPEG or WBMP, high resolution into low resolution, or full color into grayscale. Several format specific parameters can be specified, e.g., the “quality” parameter for JPEG images or the “interlaced”-parameter for PNG images.

The Preprocessor 428 (e.g., a DDL Preprocessor) preprocesses a DDL document to resolve external references and inheritance hierarchies. This results in a simplified DDL document with single <document>-block 345. By this technique, the style sheet-based transformation is eased. The preprocessing may be style sheet-based. However, as this process may be time consuming, it is possible to use a DOM-based transformation in Java. An XMLParser 426 optionally may be used between the URLGetter 418 and the Preprocessor 428.

Fragmentation 432 and FragmentationValidation 438 work together to perform the document fragmentation when restrictions of the client device 405 do not allow the particular document to be displayed as a whole. In addition to the actual fragmentation, these filters 432, 438 are responsible for the user input validation and they store input data until the final dialog part is completed.

The XSLTProcessor 434 transforms a preprocessed DDL document into a device specific format (e.g., HTML, WML, or cHTML). The transformation may be based on XSLT style sheets 440. The style sheets have access to the information in the HTTP request and the context of the processing environment. The information is made available to the style sheets as XSLT parameters.

Fragmentation 432 manages the caching of document fragments, and the fragment-by-fragment delivery to the client device 405. Furthermore, it stores input data until forms within the document are completed. Fragmentation 432 may perform the actual fragmentation of a document if the document has exceeded the resource restrictions of a client device 405. First, the document is split into the smallest indivisible parts. Then, these parts are combined into as few fragments as possible to still meet the resource constraints of the client device 405. Finally, FragmentationValidation 438 checks whether the size of the rendered document exceeds the resource restrictions of a particular client device. If this is true, the filter invokes Fragmentation 432 again to trigger another fragmentation iteration.

Wireless application protocol (WAP) devices do not process a textual WML document, but instead process a compact binary representation thereof (binary WML). A WAP gateway, i.e., an intermediary between the server and the WAP device, compiles the textual into the binary representation. Therefore, the memory restrictions of the device do not apply to the size of the textual WML document, but rather to the size of the compacted version. To check if a WML document fits the resource restrictions of the client, a WMLCompiler 436 is interposed between the XSLTProcessor 434 and the FragmentationValidation 438 to perform the conversion to binary WML.

In processing a complex DDL document, a large share of the processing time typically is consumed by the XSLTProcessorFilter 434 and the Preprocessor-Filter 428.

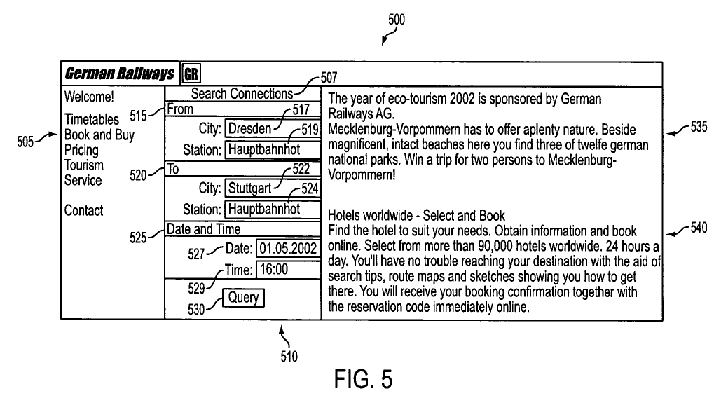

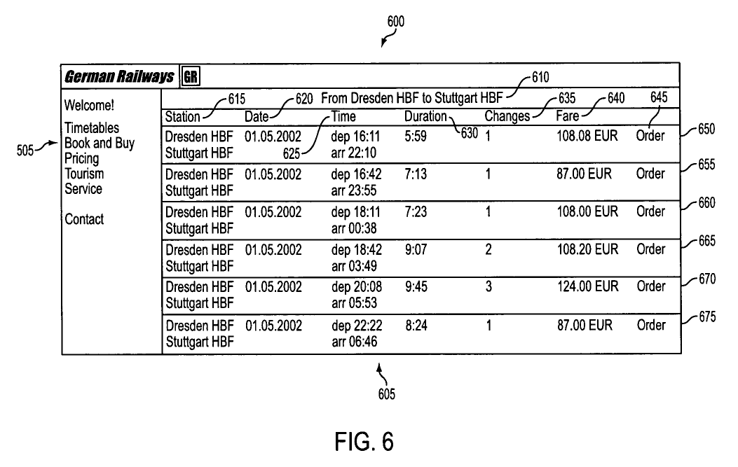

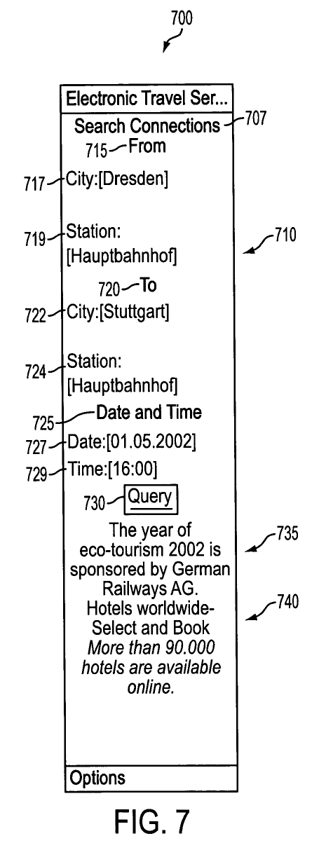

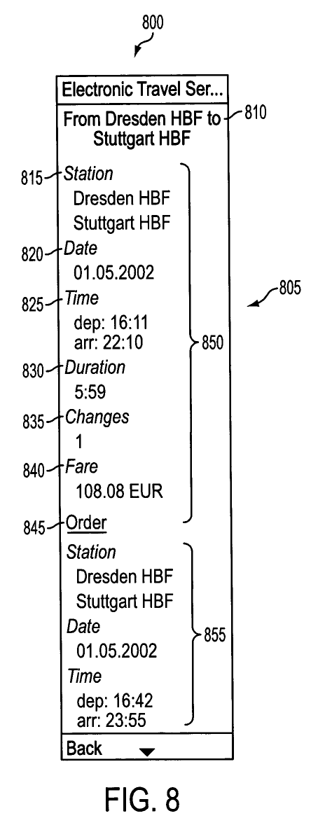

FIGS. 5-8 illustrate exemplary user interfaces 500, 600, 700, and 800 for a railway information system. The railway example is representative of dynamic and interactive web applications. The sample railway information system enables connection querying and ticket ordering in a fictitious railway company. UIs 500 and 600 are shown for desktop browsers, and UIs 700 and 800 are shown for mobile devices (e.g., mobile phones, PDAs), such as a WAP-enabled device. The mobile device representation in UI 700 corresponds to the desktop computer representation in UI 500, and the mobile device representation in UI 800 corresponds to the desktop representation in UI 600.

The comparison of the UI representations for desktop browsers 500 and 600 and UI representations for WAP browsers 700 and 800 show many differences. For example, the UI 700 omits the menu 505 of UI 500, and the two advertisement sections 535 and 540 in UI 500 are replaced by a short text 735 and 740 in UI 700. Also, in UI 800, the table 605 with the timetable for the connections in UI 600 is transformed into a list 805 with pairs of table column names 815, 820, 825, 830, 835, and 840 and table cell value on a UI for a WAP browser 800. Finally, much layout information in UIs 500 and 600 is removed and not present in UIs 700 and 800 due to the limitations of WAP devices.

In particular, UI 500 includes a menu 505 with various menu options including options to display timetables, book and buy tickets, display pricing, display tourism information, display service information, and display contact information. A search section 510 of the UI 500 enables a user to search for train connections and includes a title bar 507, a “from” section 515, including an area to input a starting city 517 and station 519, a “to” section 520, including an area to input a destination city 522 and station 524, a date and time section 525, including an area to input date 527 and a time 529 desired for the departure location in the from section 515, or alternatively in arrival date and time for the arrival location in the to section 520. A query button 530 may be provided to initiate the search. Additionally, advertising sections 535 and 540 are provided in the UI 500.

As shown in UI 600, a result of a search conducted according to the input entered through UI 500 is shown. The UI 600 includes a menu 505 and also includes a table 605 to display the search results, in this case the information concerning railroad connections. The table 605 includes columns for information concerning stations 615, arrival and departure dates 620, arrival and departure times 625, trip durations 630, train changes 635, train fares 640, and the order in which the stations are encountered during the trip 645. As shown, the table 605 includes six timetables 650, 655, 660, 665, 670, and 675 corresponding to the search results meeting the search criteria entered in UI 500.

Mobile device UI 700 corresponds to the UI 500 for a desktop computer. As shown, UI 700 includes a search section 710. The search section 710 includes a “from” section 715, including an area to input a departure city 717 and rail station 719, a “to” section 720, including an area to input an arrival city 722 and station 724. The search section 710 also includes a date and time section 725, including an area to input a date 727 and a time 729 to enter, for example, the date and time of departure or the date and time of arrival. A query control 730 is provided to initiate the desired query. The advertising sections 535 and 540 of FIG. 5 have been reduced to advertising sentences 735 and 740 in UI 700.

Mobile device UI 800 corresponds to the UI 600 for a desktop computer. In UI 800, search results are displayed for the search criteria entered in UI 700. As shown, UI 800 includes a list 805 including fields such as rail station 815, date 820, time 825, trip duration 830, train changes 835, train fare 840, and the order of stations 845 for a first connection 850. A similar timetable is also shown for a second connection 855.

Another example (not shown) of a transformation is an online newspaper application. A newspaper contains more structured and static content than the railway timetable example of FIGS. 5-8. The exemplary online newspaper tries to imitate an existing online newspaper, but adds adaptation capabilities and is described by DDL. On desktop computers, the newspaper may have a three-column layout including a narrow left column with a topic list, a broad middle column containing either selected important articles with images and short text or a single article with full text, and a narrow right column with weather forecast, stock exchange information, and user surveys. On top of the page there may be a title banner.

When using a mobile device such as a PDA or mobile phone to display the same online newspaper web page, several adaptations may be automatically performed by the adaptation framework 100. For example, the complex page layout may be split into three parts: a topic menu; a list of articles; and the article itself. Each of these parts may be displayed on a separate page on the mobile device. Image sizes may be reduced to fit on the mobile device display. If necessary, the image format may be converted, for example when using WAP mobile phones. As another example, only the first sentence of each section may be displayed in a long text article. The user may access the remaining parts through, for example, a link displayed at the end of each truncated section. Long, unstructured text strings also may be split into several parts if display of the whole text string would be displayable because, for example, it would exceed the memory capacity of a device.

The user may specify in a user profile that the user does not want to receive images at all. In this case, the adaptation framework would replace all images with an alternative text (which is added to the image within the DDL document) and add a link to the image. This is especially useful if the user has to pay for the amount of data transferred.

A modular adaptation framework supporting heterogeneous devices has been described. The framework integrates several mechanisms for the adaptation of web documents to the special properties of mobile devices. A device independent markup language DDL for the description of documents and forms has been described, and contains additional meta-information to improve the results of the automatic adaptation process. The integration of this author knowledge into the DDL enhances the usability of the device-specific markup languages generated from the device-independent DDL.

A number of implementations have been described. Nevertheless, it will be understood that various modifications may be made. Accordingly, other implementations are within the scope of the following claims.

What is claimed is:

1. A method comprising:
generating a source document, the source document including at least one event;
associating meta information with one or more of the events;
transforming the events into one or more markup language specific representations of the events, the transformation of an event being controlled at least in part by the associated meta-information;
sending at least one markup language specific representation of the events to a browser running on a client device; and
receiving from the client device one or more markup language specific events coded as HTTP-request parameters.

2. The method of claim 1 wherein generating the source document comprises generating the source document to include at least one generic, markup language independent, event.

3. The method of claim 1 wherein the source document is a web document.

4. The method of claim 3 wherein the generic, markup language independent, event is described in a generic, device-independent document description language based on XML.

5. The method of claim 4 wherein associating meta information comprises manually associating meta information with one or more of the events.

6. The method of claim 1 wherein the meta information indicates alternative representations of semantically one element.

7. The method of claim 1 wherein the meta information enables elements to be declared to be optional and to be omitted on a client device with insufficient resources.

8. The method of claim 1 wherein transforming the events comprises automatically transforming the events.

9. The method of claim 1 further comprising fragmenting the source document into two or more subdocuments and transforming the fragments into one or more markup language specific representations appropriate to available resources of the client device and an execution environment of the client device.

10. The method of claim 1 wherein the one or more markup language specific representations comprise one or more of an HTML representation, a WML representation, and a cHTML representation.

11. The method of claim 1 wherein the generic events comprise one or more of a navigation event, an input event, a relation event, and a submission event.

12. A method comprising:
generating a source document, the source document including at least one generic, markup language independent, event;
manually associating meta information with one or more of the generic events;
automatically transforming the source document generic events into one or more markup language specific representations of the source document events, the transformation of an event being controlled at least in part by the associated meta-information;
sending at least one markup language specific representation of the events to a browser running on a client device; and
receiving from the client device one or more markup language specific events coded as HTTP-request parameters.

13. An apparatus comprising a server device configured to:
generate a source document, the source document including at least one generic, markup language independent, event;
associate meta information with one or more of the events;
transform the events into one or more markup language specific representations of the events, the transformation of an event being controlled at least in part by the associated meta-information;
send at least one markup language specific representation of the events to a browser running on a client device; and
receive from the client device one or more markup language specific events coded as HTTP-request parameters.

14. The apparatus of claim 13 further comprising a server device configured to fragment the source document into two or more subdocuments and transform the fragments into one or more markup language specific representations appropriate to available resources of the client device and an execution environment of the client device.

15. An apparatus comprising:
an adaptation framework comprising:
an event dispatcher configured to process an incoming event and control an invocation of one or more processes based upon the event;
a fragment getter invoked by the event dispatcher and configured to retrieve a portion of a document from a local data store;
a processor invoked by the event dispatcher and configured to communicate with the fragment getter and configured to transform the document into a device specific format; and
a fragmentation filter invoked by the event dispatcher configured to fragment the document into one or more parts for display by a client device based upon an availability of one or more resources at the client device.

16. The apparatus of claim 15 wherein the adaptation framework further comprises a client recognizer configured to receive information from a client device and to receive device profile information.

17. The apparatus of claim 15 wherein the fragment getter is further configured to generate the document from a local data store based upon user profile data stored in a user profile.

18. The apparatus of claim 15 wherein the adaptation framework further comprises an image filter configured to adapt an image according to device profile information and user profile information.

19. The apparatus of claim 15 wherein the fragmentation filter further comprises a first fragmentation filter configured to manage caching of one or more fragments of the document and configured to perform a fragmentation of the document; and a fragmentation validation filter communicating with the first fragmentation filter configured to determine whether the fragments may be rendered on the client device without exceeding the resources of the client device, and if not, to enable further fragmentation by the first fragmentation filter.

20. The apparatus of claim 15 wherein the one or more filters are executed based upon filter configuration data stored in a filter configuration file.

21. The apparatus of claim 15 wherein a next filter to be executed is determined by a current filter being executed.
